(19) United States
(12) Patent Application Publication
(10) Pub. No.: US 2022/0210869 A1
(43) Pub. Date: Jun. 30, 2022

(54) METHOD AND DEVICE USED IN COMMUNICATION NODE FOR WIRELESS COMMUNICATION

(71) Applicant: Xiaobo ZHANG, SHANGHAI (CN)

(72) Inventor: Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/557,065

(22) Filed: Dec. 21, 2021

(30) Foreign Application Priority Data
Dec. 24, 2020 (CN) 202011547775.2

(51) Int. Cl. H04W 76/34; H04L 1/16

(52) U.S. Cl. CPC H04W 76/34; H04W 80/02; H04L 1/1628

(57) ABSTRACT

The present disclosure provides a method and a device in a communication node for wireless communications. A communication node receives a first signaling; the first signaling is used to determine release of only one of a first logical channel group or a second logical channel group; herein, the first logical channel group comprises at least one logical channel, and the second logical channel group comprises at least one logical channel; data transmitted through the first logical channel group and data transmitted through the second logical channel group are associated with a PDCP entity. The present disclosure can support lossless transmission of broadcast/multicast data in an air interface during the process of switching PTP to PTM transmission mode.

### CROSS REFERENCE TO RELATED APPLICATIONS

This application claims the priority benefit of Chinese Patent Application No. 202011547775.2, filed on Dec. 24, 2020, the full disclosure of which is incorporated herein by reference.

### BACKGROUND

### Technical Field

The present disclosure relates to transmission methods and devices in wireless communication systems, and in particular to a method and a device for multi-connection transmission.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

The technique of Broadcast/Multicast transmission has been widely applied in cellular networks, such as Multimedia Broadcast Multicast Service (MBMS) in a 4G Long Term Evolution (LIE) system. One of major characteristics of the Broadcast/Multicast transmission lies in that a network device is capable of sending the same broadcast/multicast data to multiple terminal nodes simultaneously, which is of great importance to application scenarios like broadcast television, disaster alerting, services of urgency, industrial control and Vehicle-to-Everything ones. In LTE MBMS, an eNB schedules multiple terminal nodes via a Physical Downlink Control Channel (PDCCH) to receive a Physical Downlink Shared Channel (PDSCH) or a Physical Multicast Channel (PMCH) containing broadcast/multicast data. Broadcast/multicast-related identifiers include Single Cell RNTI (SC-RNTI), Single Cell Notification RNTI (SC-N-RNTI) and Group RNTI (G-RNTI).

### SUMMARY

The network can select either Point-to-MultiPoint (PTM) or Point-to-MultiPoint (PTP) as a transmission mode for broadcast/multicast data in accordance with variations in user distribution and channel status. There might be some loss of data during a switching of transmission mode from PTP to PTM. Therefore, for supporting the lossless transmission of broadcast/multicast data in an air interface, the above two transmission modes can coexist during the process of changing the PTP transmission mode to the PTM transmission mode; generally, it is only required to keep one of those transmission modes after completing such switching, but there is still no effective way of achieving the change of transmission mode and corresponding Bearer control.

To address the above problem, the present disclosure provides a solution. In view of the description of the above problem, the scenario of Terrestrial Network (TN) has been taken as an example; The present disclosure is also applicable to scenarios such as Non-Terrestrial Network (NTN), and V2X, where technical effects similar to TN scenario can be achieved. Additionally, the adoption of a unified solution for various scenarios contributes to the reduction of hardcore complexity and costs.

In one embodiment, interpretations of the terminology in the present disclosure refer to definitions given in the 3GPP TS36 series.

In one embodiment, interpretations of the terminology in the present disclosure refer to definitions given in the 3GPP TS38 series.

In one embodiment, interpretations of the terminology in the present disclosure refer to definitions given in the 3GPP TS37 series.

In one embodiment, interpretations of the terminology in the present disclosure refer to definitions given in Institute of Electrical and Electronics Engineers (IEEE) protocol specifications.

It should be noted that if no conflict is incurred, embodiments in any node in the present disclosure and the characteristics of the embodiments are also applicable to any other node, and vice versa. What's more, the embodiments in the present disclosure and the characteristics in the embodiments can be arbitrarily combined if there is no conflict.

The present disclosure provides a method in a first node for wireless communications, comprising:

receiving a first signaling, the first signaling being used to determine release of only one of a first logical channel group or a second logical channel group;

herein, the first logical channel group comprises at least one logical channel, and the second logical channel group comprises at least one logical channel; data transmitted through the first logical channel group and data transmitted through the second logical channel group are associated with a PDCP entity.

In one embodiment, the first signaling comprises all or part of a RRCReconfiguration message.

In one embodiment, the first signaling comprises all or part of a RRCConnectionReconfiguration message.

In one embodiment, the first information comprises a Radio Resource Control (RRC) message.

In one embodiment, the first information comprises all or part of Information Elements (IEs) in an RRC message.

In one embodiment, the phrase of the first signaling being used to determine release of only one of a first logical channel group or a second logical channel group comprises: upon reception of the first signaling, stopping receiving data through the first logical channel group, the second logical channel group being activated.

In one embodiment, the phrase of the first signaling being used to determine release of only one of a first logical channel group or a second logical channel group comprises: upon reception of the first signaling, stopping receiving data through the second logical channel group, the second logical channel group being activated.

In one embodiment, the action of monitoring in the present disclosure includes: blind detection.

In one embodiment, the action of monitoring in the present disclosure includes: coherent detection on a characteristic sequence.

In one embodiment, the action of monitoring in the present disclosure includes: Cyclic Redundancy Check (CRC) check.

In one embodiment, a scheduling signaling in an air interface for the data transmitted through the first logical channel group is identified by a non-unicast RNTI, and a scheduling signaling in an air interface for the data transmitted through the second logical channel group is identified by a unicast RNTI.

In one embodiment, the unicast RNTI in the present disclosure comprises a Cell RNTI (C-RNTI).

In one embodiment, a bit size comprised in the unicast RNTI in the present disclosure is a positive integral multiple of 8.

In one embodiment, the unicast RNTI in the present disclosure comprises 24 bits.

In one embodiment, the non-unicast RNTI in the present disclosure comprises a Group RNTI (G-RNTI).

In one embodiment, a bit size comprised in the non-unicast RNTI in the present disclosure is a positive integral multiple of 8.

In one embodiment, the non-unicast RNTI in the present disclosure comprises 24 bits.

In one embodiment, a physical layer channel occupied by the data transmitted through the first logical channel group is a non-unicast channel, while a physical layer channel occupied by the data transmitted through the second logical channel group is a unicast channel.

In one embodiment, the non-unicast channel comprises a Physical Multicast Channel (PMCH).

In one embodiment, the non-unicast channel comprises a Physical Broadcast Channel (PBCH).

In one embodiment, the non-unicast channel comprises a PDSCH.

In one embodiment, the unicast channel comprises a PDSCH.

In one embodiment, the unicast channel comprises a PSSCH.

In one embodiment, the data transmitted through the first logical channel group corresponds to non-unicast traffics.

In one embodiment, the data transmitted through the second logical channel group corresponds to non-unicast traffics.

In one embodiment, the non-unicast traffics include Groupcast traffics.

In one embodiment, the non-unicast traffics include Multicast traffics.

In one embodiment, the non-unicast traffics include Broadcast traffics.

In one embodiment, the data transmitted through the first logical channel group is transmitted via a first-type packet.

In one embodiment, the data transmitted through the second logical channel group is transmitted via a first-type packet.

In one embodiment, the first-type packet comprises: a PDCP Protocol Date Unit (PDU).

In one embodiment, the first-type packet comprises: a PDCP Service Date Unit (SDU).

In one embodiment, the phrase that the data transmitted through the first logical channel group and data transmitted through the second logical channel group are associated with a PDCP entity comprises: data transmitted through the first logical channel group and data transmitted through the second logical channel group are associated with one RLC entity, and the RLC entity is associated with the PDCP entity.

In one embodiment, the phrase that the data transmitted through the first logical channel group and data transmitted through the second logical channel group are associated with a PDCP entity comprises: data transmitted through the first logical channel group and data transmitted through the second logical channel group are respectively associated with two RLC entities, and the two RLC entities are associated with the PDCP entity.

According to one aspect of the present disclosure, characterized in that the first signaling being used to determine release of only one of a first logical channel group or a second logical channel group comprises: when the first signaling is identified by a non-unicast RNTI, the first logical channel group is released; when the first signaling is identified by a unicast RNTI, the first logical channel group is retained.

In one embodiment, whether the first logical channel group is to be released or retained is determined according to whether the first signaling is identified by a non-unicast RNTI or a unicast RNTI.

In one embodiment, whether the first logical channel group is to be released or retained depends upon whether the first signaling is identified by a non-unicast RNTI or a unicast RNTI.

In one embodiment, the action that the first logical channel group is released comprises: configurations of the first logical channel group are released.

In one embodiment, the action that the first logical channel group is released comprises: stopping monitoring on a scheduling signaling in an air interface for the data transmitted through the first logical channel group.

In one embodiment, the action that the first logical channel group is released comprises: configurations of a Radio Bearer (RB) to which the first logical channel group belongs are released.

In one embodiment, configurations of an RB to which the first logical channel group belongs include at least one of a PDCP entity configuration, a SDAP entity configuration, an RLC entity configuration or a logical channel configuration.

According to one more aspect of the present disclosure, characterized in that the first signaling being used to determine release of only one of a first logical channel group or a second logical channel group comprises: the first signaling indicates a first threshold, the first threshold being used to determine release of the second logical channel group.

In one embodiment, the action that the second logical channel group is released comprises: configurations of the second logical channel group are released.

In one embodiment, the action that the second logical channel group is released comprises: stopping monitoring on a scheduling signaling in an air interface for the data transmitted through the second logical channel group.

In one embodiment, the action that the second logical channel group is released comprises: configurations of a Radio Bearer (RB) to which the second logical channel group belongs are released.

In one embodiment, the phrase that the first threshold being used to determine release of the second logical channel group comprises: when a second sequence number is greater than or equal to a first threshold, the second logical channel group is released.

In one embodiment, the phrase that the first threshold being used to determine release of the second logical channel group comprises: when a difference between a second sequence number and a first sequence number is less than a first threshold, the second logical channel group is released.

In one embodiment, the second sequence number in the present disclosure comprises: a sequence number of a first-type packet occupied by data transmitted through the second logical channel group.

In one subembodiment, the first-type packet is successfully received.

In one subembodiment, the first-type packet is correctly received.

In one subembodiment, the first-type packet is in a receiving window, the receiving window belonging to a protocol layer to which the first-type packet belongs.

In one subembodiment, the first-type packet is a largest first-type packet among all first-type packets occupied by data transmitted through the second logical channel group.

In one embodiment, the first sequence number in the present disclosure comprises: a sequence number of a first-type packet occupied by data transmitted through the first logical channel group.

In one subembodiment, the first-type packet is successfully received.

In one subembodiment, the first-type packet is correctly received.

In one subembodiment, the first-type packet is in a receiving window, the receiving window belonging to a protocol layer to which the first-type packet belongs.

In one subembodiment, the first-type packet is a largest first-type packet among all first-type packets occupied by data transmitted through the first logical channel group.

The present disclosure provides a method in a second node for wireless communications, comprising:

transmitting a first signaling, the first signaling being used to determine release of only one of a first logical channel group or a second logical channel group;

herein, the first logical channel group comprises at least one logical channel, and the second logical channel group comprises at least one logical channel; data transmitted through the first logical channel group and data transmitted through the second logical channel group are associated with a PDCP entity.

The present disclosure provides a first node for wireless communications, comprising:

a first receiver, receiving a first signaling, the first signaling being used to determine release of only one of a first logical channel group or a second logical channel group;

herein, the first logical channel group comprises at least one logical channel, and the second logical channel group comprises at least one logical channel; data transmitted through the first logical channel group and data transmitted through the second logical channel group are associated with a PDCP entity.

The present disclosure provides a second node for wireless communications, comprising:

a second transmitter, transmitting a first signaling, the first signaling being used to determine release of only one of a first logical channel group or a second logical channel group;

herein, the first logical channel group comprises at least one logical channel, and the second logical channel group comprises at least one logical channel; data transmitted through the first logical channel group and data transmitted through the second logical channel group are associated with a PDCP entity.

In one embodiment, a problem to be solved in the present disclosure includes: Radio Bearer control when changing to a new transmission mode, like Radio Bearer release.

In one embodiment, advantages of the above method are as follows: Releasing extra RBs, to reduce power consumption and increase the resource utilization ratio.

In one embodiment, advantages of the above method are as follows: Supporting lossless transmission of broadcast/multicast data in an air interface when switching between PTP and PTM transmission modes.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of transmission of a first signaling according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5 illustrates a flowchart of radio signal transmission according to one embodiment of the present disclosure.

FIG. 6 illustrates a flowchart of radio signal transmission according to another embodiment of the present disclosure.

FIG. 7 illustrates a structure block diagram of a processing device used in a first node according to one embodiment of the present disclosure.

FIG. 8 illustrates a structure block diagram of a processing device used in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

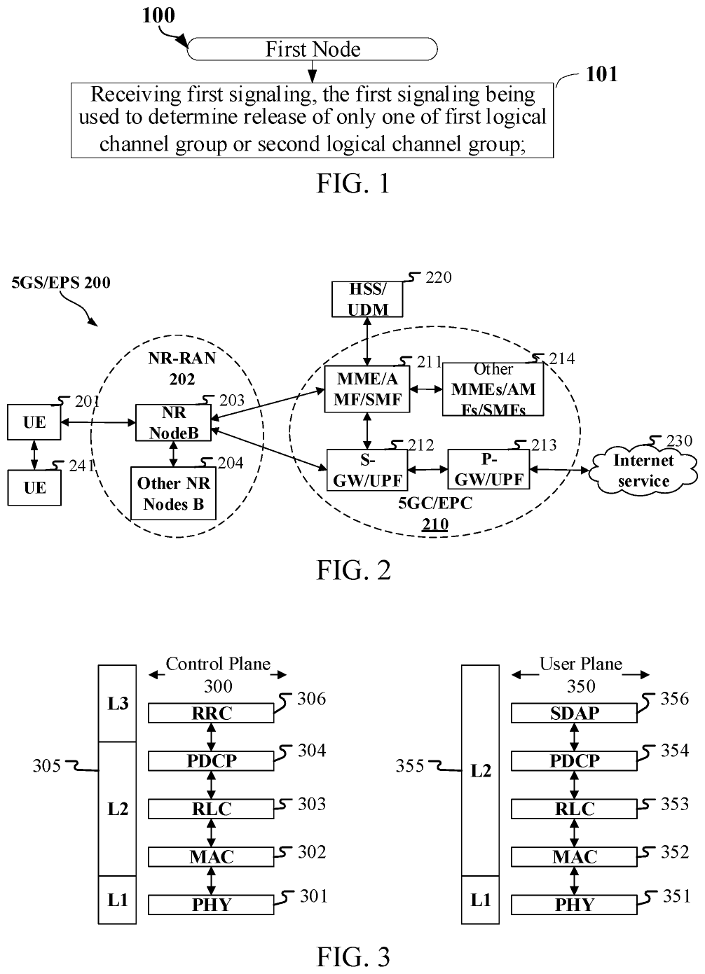

Embodiment 1 illustrates a flowchart of transmission of a first signaling according to one embodiment of the present disclosure, as shown in FIG. 1. In FIG. 1, each step represents a step, it should be particularly noted that the sequence order of each box herein does not imply a chronological order of steps marked respectively by these boxes.

In Embodiment 1, the first node in the present disclosure receives a first signaling, the first signaling being used to determine release of only one of a first logical channel group or a second logical channel group.

Herein, the first logical channel group comprises at least one logical channel, and the second logical channel group comprises at least one logical channel; data transmitted through the first logical channel group and data transmitted through the second logical channel group are associated with a PDCP entity.

In one embodiment, the first signaling comprises all or part of a RRCReconfiguration message.

In one embodiment, the first signaling comprises all or part of a RRCConnectionReconfiguration message.

In one embodiment, the first information comprises a Radio Resource Control (RRC) message.

In one embodiment, the first information comprises all or part of Information Elements (IEs) in an RRC message.

In one embodiment, the first information comprises all or part of fields of an IE in an RRC message.

In one embodiment, the phrase of the first signaling being used to determine release of only one of a first logical channel group or a second logical channel group comprises: upon reception of the first signaling, stopping receiving data through the first logical channel group.

In one embodiment, the phrase of the first signaling being used to determine release of only one of a first logical channel group or a second logical channel group comprises: upon reception of the first signaling, stopping receiving data through the second logical channel group.

In one embodiment, the phrase of the first signaling being used to determine release of only one of a first logical channel group or a second logical channel group comprises: upon reception of the first signaling, stopping receiving data through an RB to which the first logical channel group belongs.

In one embodiment, the phrase of the first signaling being used to determine release of only one of a first logical channel group or a second logical channel group comprises: upon reception of the first signaling, stopping receiving data through an RB to which the second logical channel group belongs.

In one embodiment, the RB to which the first logical channel group belongs in the present disclosure comprises a Multicast Radio Bearer (MRB).

In one embodiment, the RB to which the first logical channel group belongs in the present disclosure comprises a Multicast and Broadcast Service-Radio Bearer (MBS-RB).

In one embodiment, the RB to which the first logical channel group belongs in the present disclosure comprises a Single Cell-Multicast Radio Bearer (SC-MRB).

In one embodiment, the RB to which the first logical channel group belongs in the present disclosure comprises a Data Radio Bearer (DRB).

In one embodiment, the RB to which the first logical channel group belongs in the present disclosure comprises an RLC channel.

In one embodiment, the RB to which the first logical channel group belongs in the present disclosure comprises an RLC Bearer.

In one embodiment, the RB to which the first logical channel group belongs in the present disclosure comprises an RB transmitted in a Point-to-Point (PTP) mode.

In one embodiment, the RB to which the first logical channel group belongs in the present disclosure comprises an RB transmitted in a Point-to-MultiPoint (PTM) mode.

In one embodiment, the RB to which the first logical channel group belongs in the present disclosure comprises a PTP branch.

In one embodiment, the PTP branch comprises a leg.

In one embodiment, the PTP branch comprises a link.

In one embodiment, the PTP branch comprises a branch.

In one embodiment, the RB to which the first logical channel group belongs in the present disclosure comprises a PTM branch.

In one embodiment, the PTM branch comprises a leg.

In one embodiment, the PTM branch comprises a link.

In one embodiment, the PTM branch comprises a branch.

In one embodiment, the RB to which the second logical channel group belongs in the present disclosure comprises a Multicast Radio Bearer (MRB).

In one embodiment, the RB to which the second logical channel group belongs in the present disclosure comprises a Multicast and Broadcast Service-Radio Bearer (MBS-RB).

In one embodiment, the RB to which the second logical channel group belongs in the present disclosure comprises a Single Cell-Multicast Radio Bearer (SC-MRB).

In one embodiment, the RB to which the second logical channel group belongs in the present disclosure comprises a Data Radio Bearer (DRB).

In one embodiment, the RB to which the second logical channel group belongs in the present disclosure comprises an RLC channel.

In one embodiment, the RB to which the second logical channel group belongs in the present disclosure comprises an RLC Bearer.

In one embodiment, the RB to which the second logical channel group belongs in the present disclosure comprises an RB transmitted in a Point-to-Point (PTP) mode.

In one embodiment, the RB to which the second logical channel group belongs in the present disclosure comprises an RB transmitted in a Point-to-MultiPoint (PTM) mode.

In one embodiment, the RB to which the second logical channel group belongs in the present disclosure comprises a PTP branch.

In one embodiment, the PTP branch comprises a leg.

In one embodiment, the PTP branch comprises a link.

In one embodiment, the PTP branch comprises a branch.

In one embodiment, the RB to which the second logical channel group belongs in the present disclosure comprises a PTM branch.

In one embodiment, the PTM branch comprises a leg.

In one embodiment, the PTM branch comprises a link.

In one embodiment, the PTM branch comprises a branch.

In one embodiment, the phrase of the first signaling being used to determine release of only one of a first logical channel group or a second logical channel group comprises: stopping monitoring on a scheduling signaling in an air interface for the data transmitted through the first logical channel group.

In one embodiment, the phrase of the first signaling being used to determine release of only one of a first logical channel group or a second logical channel group comprises: stopping monitoring on a scheduling signaling in an air interface for the data transmitted through the second logical channel group.

In one embodiment, the action of monitoring in the present disclosure includes: blind detection.

In one embodiment, the action of monitoring in the present disclosure includes: coherent detection on a characteristic sequence.

In one embodiment, the action of monitoring in the present disclosure includes: Cyclic Redundancy Check (CRC) check.

In one embodiment, the action of monitoring in the present disclosure includes: monitoring.

In one embodiment, the action of monitoring a scheduling signaling in an air interface for the data transmitted through the first logical channel group comprises: monitoring on whether there is the scheduling signaling on a physical channel occupied by the scheduling signaling.

In one embodiment, the action of monitoring a scheduling signaling in an air interface for the data transmitted through the second logical channel group comprises: monitoring on whether there is the scheduling signaling on a physical channel occupied by the scheduling signaling.

In one embodiment, the first logical channel group and the second logical channel group are simultaneously configured.

In one embodiment, the first logical channel group is configured prior to the second logical channel group.

In one embodiment, the first logical channel group is configured after the second logical channel group.

In one embodiment, the first logical channel group and the second logical channel group are respectively configured by different RRC signalings.

In one embodiment, the first logical channel group and the second logical channel group are configured by a same RRC signaling.

In one embodiment, the first logical channel group comprises multiple logical channels, and the logical channel is one of the multiple logical channels.

In one embodiment, the first logical channel group comprises K1 logical channels, and the logical channel is one of the K1 logical channels.

In one subembodiment, K1 is a positive integer greater than 1.

In one embodiment, the first logical channel group comprises multiple logical channels, and the logical channel is one of the multiple logical channels.

In one embodiment, the first logical channel group comprises K2 logical channels, and the logical channel is one of the K2 logical channels.

In one subembodiment, K2 is a positive integer greater than 1.

In one embodiment, the data transmitted through the first logical channel group corresponds to non-unicast traffics.

In one embodiment, the data transmitted through the second logical channel group corresponds to non-unicast traffics.

In one embodiment, the non-unicast traffics include Groupcast traffics.

In one embodiment, the non-unicast traffics include Multicast traffics.

In one embodiment, the non-unicast traffics include Broadcast traffics.

In one embodiment, the data transmitted through the first logical channel group is transmitted via a first-type packet.

In one embodiment, the data transmitted through the second logical channel group is transmitted via a first-type packet.

In one embodiment, the first-type packet comprises: a PDCP Protocol Date Unit (PDU).

In one embodiment, the first-type packet comprises: a PDCP Service Date Unit (SDU).

In one embodiment, the first-type packet comprises: RLC PDU.

In one embodiment, the first-type packet comprises: RLC SDU.

In one embodiment, the data transmitted through the first logical channel group corresponds to unicast traffics.

In one embodiment, the data transmitted through the second logical channel group corresponds to unicast traffics.

In one embodiment, the action of transmission comprises: transmitting/sending.

In one embodiment, the action of transmission comprises: transmitting.

In one embodiment, the action of transmission comprises: receiving.

In one embodiment, the phrase that the data transmitted through the first logical channel group and data transmitted through the second logical channel group are associated with a PDCP entity comprises: data transmitted through the first logical channel group and data transmitted through the second logical channel group are associated with one RLC entity, and the RLC entity is associated with the PDCP entity.

In one embodiment, the phrase that the data transmitted through the first logical channel group and data transmitted through the second logical channel group are associated with a PDCP entity comprises: data transmitted through the first logical channel group and data transmitted through the second logical channel group are respectively associated with two RLC entities, and the two RLC entities are associated with the PDCP entity.

In one embodiment, the phrase that the data transmitted through the first logical channel group and data transmitted through the second logical channel group are associated with a PDCP entity comprises: the first logical channel group and the second logical channel group are associated with one RLC entity, and the RLC entity is associated with the PDCP entity.

In one embodiment, the phrase that the data transmitted through the first logical channel group and data transmitted through the second logical channel group are associated with a PDCP entity comprises: the first logical channel group and the second logical channel group are respectively associated with two RLC entities, and the two RLC entities are associated with the PDCP entity.

In one embodiment, the phrase that the data transmitted through the first logical channel group and data transmitted through the second logical channel group are associated with a PDCP entity comprises: the first logical channel group and the second logical channel group respectively belong to two RLC Bearers, and the two RLC Bearers are associated with the PDCP entity.

In one embodiment, the phrase of data transmitted through the first logical channel group comprises: data transmitted through any logical channel in the first logical channel group.

In one embodiment, the phrase of data transmitted through the first logical channel group comprises:

data transmitted through at least one logical channel in the first logical channel group.

In one embodiment, the phrase of data transmitted through the second logical channel group comprises: data transmitted through any logical channel in the second logical channel group.

In one embodiment, the phrase of data transmitted through the second logical channel group comprises: data transmitted through at least one logical channel in the second logical channel group.

In one embodiment, a scheduling signaling in an air interface for the data transmitted through the first logical channel group is identified by a non-unicast RNTI, and a scheduling signaling in an air interface for the data transmitted through the second logical channel group is identified by a unicast RNTI.

In one embodiment, the phrase of non-unicast in the present disclosure includes Groupcast.

In one embodiment, the phrase of non-unicast in the present disclosure includes Multicast.

In one embodiment, the phrase of non-unicast in the present disclosure includes Broadcast.

In one embodiment, the unicast RNTI in the present disclosure comprises a Cell RNTI (C-RNTI).

In one embodiment, a bit size comprised in the unicast RNTI in the present disclosure is a positive integral multiple of 8.

In one embodiment, the unicast RNTI in the present disclosure comprises 16 bits.

In one embodiment, the unicast RNTI in the present disclosure comprises 24 bits.

In one embodiment, the non-unicast RNTI in the present disclosure comprises a Group RNTI (G-RNTI).

In one embodiment, the non-unicast RNTI in the present disclosure comprises a Multicast and Broadcast Service RNTI (MBS-RNTI).

In one embodiment, a bit size comprised in the non-unicast RNTI in the present disclosure is a positive integral multiple of 8.

In one embodiment, the non-unicast RNTI in the present disclosure comprises 16 bits.

In one embodiment, the non-unicast RNTI in the present disclosure comprises 24 bits.

In one embodiment, the phrase that a scheduling signaling in an air interface for the data transmitted through the first logical channel group is identified by a non-unicast RNTI comprises: whether the scheduling signaling in an air interface for the data transmitted through the first logical channel group exists is determined according to the non-unicast RNTI.

In one embodiment, the phrase that a scheduling signaling in an air interface for the data transmitted through the first logical channel group is identified by a non-unicast RNTI comprises: time-frequency resources occupied by transmission of the scheduling signaling in an air interface for the data transmitted through the first logical channel group are determined according to the non-unicast RNTI.

In one embodiment, the phrase that a scheduling signaling in an air interface for the data transmitted through the first logical channel group is identified by a non-unicast RNTI comprises: the non-unicast RNTI is used for CRC scrambling for the scheduling signaling in an air interface for the data transmitted through the first logical channel group.

In one embodiment, the phrase that a scheduling signaling in an air interface for the data transmitted through the first logical channel group is identified by a unicast RNTI comprises: whether the scheduling signaling in an air interface for the data transmitted through the first logical channel group exists is determined according to the unicast RNTI.

In one embodiment, the phrase that a scheduling signaling in an air interface for the data transmitted through the first logical channel group is identified by a unicast RNTI comprises: time-frequency resources occupied by transmission of the scheduling signaling in an air interface for the data transmitted through the first logical channel group are determined according to the unicast RNTI.

In one embodiment, the phrase that a scheduling signaling in an air interface for the data transmitted through the first logical channel group is identified by a unicast RNTI comprises: the unicast RNTI is used for CRC scrambling for the scheduling signaling in an air interface for the data transmitted through the first logical channel group.

In one embodiment, the data transmitted through the first logical channel group is transmitted on a Physical Downlink Shared Channel (PDSCH).

In one embodiment, the data transmitted through the first logical channel group is transmitted on a Physical Sidelink Shared CHannel (PSSCH).

In one embodiment, the data transmitted through the second logical channel group is transmitted on a PDSCH.

In one embodiment, the data transmitted through the second logical channel group is transmitted on a PSSCH.

In one embodiment, the phrase of a scheduling signaling in an air interface for the data transmitted through the first logical channel group comprises Downlink Control Information (DCI).

In one embodiment, the phrase of a scheduling signaling in an air interface for the data transmitted through the first logical channel group comprises Sidelink Control Information (SCI).

In one embodiment, the phrase of a scheduling signaling in an air interface for the data transmitted through the first logical channel group comprises physical layer signaling.

In one embodiment, a scheduling signaling in an air interface for the data transmitted through the first logical channel group is transmitted on a Physical Downlink Control Channel (PDCCH).

In one embodiment, a scheduling signaling in an air interface for the data transmitted through the first logical channel group is transmitted on a PCCCH.

In one embodiment, a physical layer channel occupied by the data transmitted through the first logical channel group is a unicast channel, while a physical layer channel occupied by the data transmitted through the second logical channel group is a unicast channel.

In one embodiment, a physical layer channel occupied by the data transmitted through the first logical channel group is a non-unicast channel, while a physical layer channel occupied by the data transmitted through the second logical channel group is a unicast channel.

In one embodiment, the non-unicast channel comprises a Physical Multicast Channel (PMCH).

In one embodiment, the non-unicast channel comprises a Physical Broadcast Channel (PBCH).

In one embodiment, the non-unicast channel comprises a PDSCH.

In one embodiment, the unicast channel comprises a PDSCH.

In one embodiment, the unicast channel comprises a PSSCH.

In one embodiment, the phrase of the first signaling being used to determine release of only one of a first logical channel group or a second logical channel group comprises: when the first signaling is identified by a non-unicast RNTI, the first logical channel group is released; when the first signaling is identified by a unicast RNTI, the first logical channel group is retained.

In one embodiment, the phrase of the first signaling being used to determine release of only one of a first logical channel group or a second logical channel group comprises: the first signaling indicates a first threshold, the first threshold being used to determine release of the second logical channel group.

In one embodiment, the first signaling comprises configurations of the second logical channel group.

In one embodiment, the phrase of configurations of the second logical channel group comprises: configuration of an RB to which the second logical channel group belongs.

In one embodiment, the phrase of configurations of the second logical channel group comprises: configuration of any logical channel in the second logical channel group.

In one embodiment, the phrase of configurations of the second logical channel group comprises: configuration of at least one logical channel in the second logical channel group.

In one embodiment, the phrase of configurations of the second logical channel group comprises: configurations of all logical channels in the second logical channel group.

In one embodiment, the configurations of the second logical channel group comprise at least one of a Buffer Status Report (BSR) configuration or a logical channel group identity.

In one embodiment, configurations of any logical channel in the second logical channel group comprise at least one of an identity, a priority, or a Scheduling Request (RS) identity of the logical channel, or a logical channel group identity.

In one embodiment, configurations of an RB to which the second logical channel group belongs include at least one of an RB identity, a PDCP entity configuration, a SDAP entity configuration, an RLC entity configuration or a logical channel configuration.

In one embodiment, configurations of an RB to which the second logical channel group belongs include at least one of an RB identity, a PDCP configuration, a SDAP configuration, an RLC Bearer configuration or a MAC configuration.

In one embodiment, the RLC Bearer configuration comprises at least one of a logical channel identity, an RLC configuration, a logical channel configuration or an RB identity to which the RLC Bearer configuration belongs.

In one embodiment, upon reception of the first signaling, the second logical channel group is established.

In one embodiment, upon reception of the first signaling, the second logical channel group is activated.

In one embodiment, a problem to be solved in the present disclosure includes: Radio Bearer control when changing to a new transmission mode, like Radio Bearer release.

In one embodiment, advantages of the above method are as follows: releasing extra RBs, so as to reduce power consumption and increase the resource utilization ratio.

In one embodiment, advantages of the above method are as follows: supporting lossless transmission of broadcast/multicast data in an air interface when switching between PTP and PTM transmission modes.

### Embodiment 2

Embodiment 2 illustrates a schematic diagram of a network architecture according to one embodiment of the present disclosure, as shown in FIG. 2. FIG. 2 is a diagram illustrating a network architecture 200 of 5G NR, Long-Term Evolution (LIE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present disclosure can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present disclosure.

In one embodiment, the UE 201 supports transmissions in NTN.

In one embodiment, the UE 201 supports transmissions in large-delay-difference networks.

In one embodiment, the UE 201 supports transmissions in TN.

In one embodiment, the UE 201 is a UE.

In one embodiment, the UE 201 is an aircraft.

In one embodiment, the UE 201 is a vehicle-mounted terminal.

In one embodiment, the UE 201 is a relay.

In one embodiment, the UE 201 is a vessel.

In one embodiment, the UE 201 is an IoT terminal.

In one embodiment, the UE 201 is an IoT terminal.

In one embodiment, the UE 201 is a piece of equipment supporting transmissions with low delay and high reliability.

In one embodiment, the gNB203 corresponds to the second node in the present disclosure.

In one embodiment, the gNB203 comprises a primary node.

In one embodiment, the gNB203 comprises a secondary node.

In one embodiment, the gNB203 comprises a Basestation (BS).

In one embodiment, the gNB203 comprises a UE.

In one embodiment, the gNB203 supports transmissions in NTN.

In one embodiment, the gNB203 supports transmissions in large-delay-difference networks.

In one embodiment, the gNB203 supports transmissions in TN.

In one embodiment, the gNB 203 is a MacroCellular base station.

In one embodiment, the gNB203 is a Micro Cell base station.

In one embodiment, the gNB203 is a Pico Cell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

In one embodiment, the gNB203 is a UE.

In one embodiment, the gNB203 is a Gateway.

In one embodiment, the gNB203 is an NR-supporting base station.

In one embodiment, the gNB203 is an EUTRA-supporting base station.

In one embodiment, the gNB203 is a WLAN-supporting base station.

In one embodiment, the gNB203 is a BT-supporting base station.

### Embodiment 3

Embodiment 3 illustrates a schematic diagram of a radio protocol architecture of a user plane and a control plane according to the present disclosure, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are a layer 1, a layer 2 and a layer 3, respectively. The layer 1 (L1) is the lowest layer which performs signal processing functions of various PHY layers. The L1 is called PHY 301 in the present disclosure. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first signaling in the present disclosure is generated by the RRC 306.

### Embodiment 4

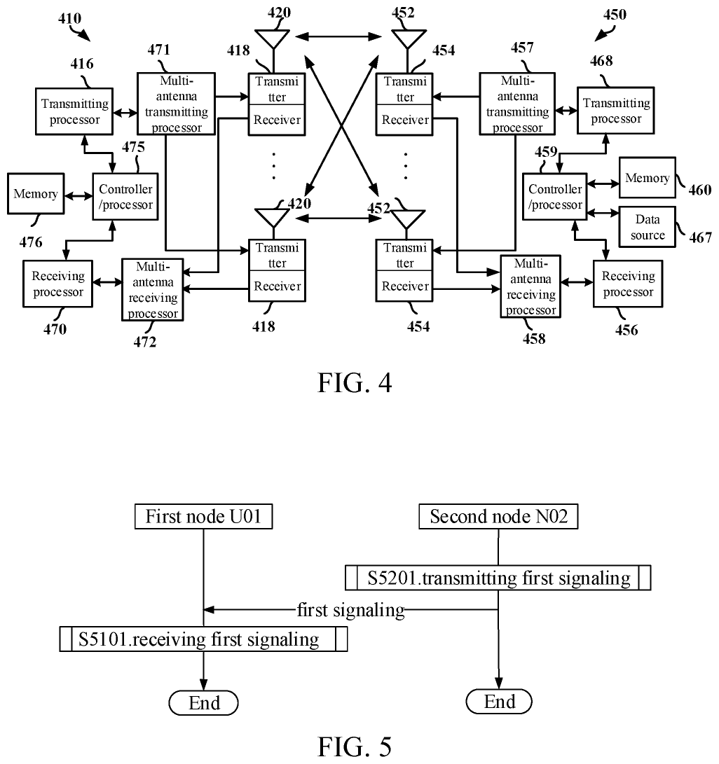

Embodiment 4 illustrates a schematic diagram of a first communication device and a second communication device according to the present disclosure, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication node 450 comprises at least one processor and at least one memory, the at least one memory comprises computer program codes; the at least one memory and the computer program codes are configured to be used in collaboration with the at least one processor. the first communication device 450 at least: receives a first signaling, the first signaling being used to determine release of only one of a first logical channel group or a second logical channel group; herein, the first logical channel group comprises at least one logical channel, and the second logical channel group comprises at least one logical channel; data transmitted through the first logical channel group and data transmitted through the second logical channel group are associated with a PDCP entity.

In one embodiment, the first communication node 450 comprises a memory that stores computer readable instruction program, the computer readable instruction program generates an action when executed by at least one processor, which includes: receiving a first signaling, the first signaling being used to determine release of only one of a first logical channel group or a second logical channel group; herein, the first logical channel group comprises at least one logical channel, and the second logical channel group comprises at least one logical channel; data transmitted through the first logical channel group and data transmitted through the second logical channel group are associated with a PDCP entity.

In one embodiment, the second communication node 410 comprises at least one processor and at least one memory, the at least one memory comprises computer program codes; the at least one memory and the computer program codes are configured to be used in collaboration with the at least one processor. The second communication device 410 at least: transmits a first signaling, the first signaling being used to determine release of only one of a first logical channel group or a second logical channel group; herein, the first logical channel group comprises at least one logical channel, and the second logical channel group comprises at least one logical channel; data transmitted through the first logical channel group and data transmitted through the second logical channel group are associated with a PDCP entity.

In one embodiment, the second communication node 410 comprises a memory that stores computer readable instruction program, the computer readable instruction program generates an action when executed by at least one processor, which includes: transmitting a first signaling, the first signaling being used to determine release of only one of a first logical channel group or a second logical channel group; herein, the first logical channel group comprises at least one logical channel, and the second logical channel group comprises at least one logical channel; data transmitted through the first logical channel group and data transmitted through the second logical channel group are associated with a PDCP entity.

In one embodiment, the antenna 452, the receiver 454, the receiving processor 456, and the controller/processor 459 are used for receiving a first signaling; at least one of the antenna 420, the transmitter 418, the transmitting processor 416 or the controller/processor 475 is used for transmitting a first signaling.

In one embodiment, the antenna 452, the transmitter 454, the transmitting processor 468 and the controller/processor 459 are used for transmitting a first signaling; at least one of the antenna 420, the receiver 418, the receiving processor 470 or the controller/processor 475 is used for receiving a first signaling.

In one embodiment, the first communication device 450 corresponds to the first node in the present disclosure.

In one embodiment, the second communication device 410 corresponds to the second node in the present disclosure.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

In one embodiment, the second communication device 410 is a UE.

### Embodiment 5

Embodiment 5 illustrates a flowchart of signal transmission according to one embodiment of the present disclosure, as shown in FIG. 5. It should be particularly noted that the sequence illustrated herein does not set any limit to the signal transmission order or implementation order in the present disclosure.

The first node U01 receives a first signaling in step S5101, when the first signaling is identified by a non-unicast RNTI, the first logical channel group is released; when the first signaling is identified by a unicast RNTI, the first logical channel group is retained.

The second node N02 transmits a first signaling in step S5201.

In Embodiment 5, the first logical channel group comprises at least one logical channel, and the second logical channel group comprises at least one logical channel; data transmitted through the first logical channel group and data transmitted through the second logical channel group are associated with a PDCP entity.

In one embodiment, whether the first logical channel group is to be released or retained is determined according to whether the first signaling is identified by a non-unicast RNTI or a unicast RNTI.

In one embodiment, whether the first logical channel group is to be released or retained is determined according to whether the first signaling is identified by a unicast RNTI.

In one embodiment, whether the first logical channel group is to be released or retained is determined according to whether the first signaling is identified by a non-unicast RNTI.

In one embodiment, whether the first logical channel group is to be released or retained depends upon whether the first signaling is identified by a non-unicast RNTI or a unicast RNTI.

In one embodiment, whether the first logical channel group is to be released or retained depends upon whether the first signaling is identified by a non-unicast RNTI.

In one embodiment, whether the first logical channel group is to be released or retained depends upon whether the first signaling is identified by a unicast RNTI.

In one embodiment, the phrase that the first signaling is identified by a non-unicast RNTI comprises: a physical layer channel occupied by transmission of the first signaling is identified by a non-unicast RNTI.

In one embodiment, the phrase that a physical layer channel occupied by transmission of the first signaling is identified by a non-unicast RNTI comprises: the non-unicast RNTI is used for Cyclic Redundancy Check (CRC) scrambling of a physical layer channel occupied by transmission of the first signaling.

In one embodiment, the phrase that a physical layer channel occupied by transmission of the first signaling is identified by a non-unicast RNTI comprises: the non-unicast RNTI is used for generating a Random Sequence (RS) of a DeModulation Reference Signal (DMRS) of a physical layer channel occupied by transmission of the first signaling.

In one embodiment, the phrase that the first signaling is identified by a non-unicast RNTI comprises: a scheduling signaling in an air interface for the first signaling is identified by a non-unicast RNTI.

In one embodiment, the phrase that a scheduling signaling in an air interface for the first signaling is identified by a non-unicast RNTI comprises: determining whether there is a scheduling signaling in an air interface for the first signaling according to the non-unicast RNTI.

In one embodiment, the phrase that a scheduling signaling in an air interface for the first signaling is identified by a non-unicast RNTI comprises: determining time-frequency resources occupied by transmission of the first signaling according to the non-unicast RNTI.

In one embodiment, the phrase that a scheduling signaling in an air interface for the first signaling is identified by a non-unicast RNTI comprises: the non-unicast RNTI is used for CRC scrambling of a scheduling signaling in an air interface for the first signaling.

In one embodiment, the phrase that the first signaling is identified by a unicast RNTI comprises: a physical layer channel occupied by transmission of the first signaling is identified by a unicast RNTI.

In one embodiment, the phrase that a physical layer channel occupied by transmission of the first signaling is identified by a unicast RNTI comprises: the non-unicast RNTI is used for CRC scrambling of a physical layer channel occupied by transmission of the first signaling.

In one embodiment, the phrase that a physical layer channel occupied by transmission of the first signaling is identified by a unicast RNTI comprises: the unicast RNTI is used for generating a RS of a DMRS of a physical layer channel occupied by transmission of the first signaling.

In one embodiment, the phrase that the first signaling is identified by a unicast RNTI comprises: a scheduling signaling in an air interface for the first signaling is identified by a unicast RNTI.

In one embodiment, the phrase that a scheduling signaling in an air interface for the first signaling is identified by a unicast RNTI comprises: determining whether there is a scheduling signaling in an air interface for the first signaling according to the unicast RNTI.

In one embodiment, the phrase that a scheduling signaling in an air interface for the first signaling is identified by a unicast RNTI comprises: determining time-frequency resources occupied by transmission of the first signaling according to the unicast RNTI.

In one embodiment, the phrase that a scheduling signaling in an air interface for the first signaling is identified by a unicast RNTI comprises: the unicast RNTI is used for CRC scrambling of a scheduling signaling in an air interface for the first signaling.

In one embodiment, the action that the first logical channel group is released comprises: configurations of the first logical channel group are released.

In one embodiment, the action that the first logical channel group is released comprises: at least one logical channel in the first logical channel group is released.

In one embodiment, the action that the first logical channel group is released comprises: configuration of at least one logical channel in the first logical channel group is released.

In one embodiment, the action that the first logical channel group is released comprises: any logical channel in the first logical channel group is released.

In one embodiment, the action that the first logical channel group is released comprises: configuration of any logical channel in the first logical channel group is released.

In one embodiment, the action that the first logical channel group is released comprises: each logical channel in the first logical channel group is released.

In one embodiment, the action that the first logical channel group is released comprises: configurations of all logical channels in the first logical channel group are released.

In one embodiment, the action that the first logical channel group is released comprises: reception of data transmitted through the first logical channel group is halted.

In one embodiment, the action that the first logical channel group is released comprises: stopping monitoring on a scheduling signaling in an air interface for the data transmitted through the first logical channel group.

In one embodiment, the action that the first logical channel group is released comprises: configurations of a Radio Bearer (RB) to which the first logical channel group belongs are released.

In one embodiment, the action that the first logical channel group is released comprises: a Radio Bearer (RB) to which the first logical channel group belongs is released.

In one subembodiment, the action that a Radio Bearer (RB) to which the first logical channel group belongs is released comprises: a PDCP entity of a Radio Bearer (RB) to which the first logical channel group belongs is released.

In one subembodiment, the action that a Radio Bearer (RB) to which the first logical channel group belongs is released comprises: an RLC entity of a Radio Bearer (RB) to which the first logical channel group belongs is released.

In one subembodiment, the action that a Radio Bearer (RB) to which the first logical channel group belongs is released comprises: a logical channel for an RLC entity of a Radio Bearer (RB) to which the first logical channel group belongs is released.

In one embodiment, the action that the first logical channel group is retained comprises: configurations of the first logical channel group are retained.

In one embodiment, the action that the first logical channel group is retained comprises: configuration of any logical channel in the first logical channel group is retained.

In one embodiment, advantages of the above method are as follows: configurations of the first logical channel group retained can be utilized in follow-up process to activate the first logical channel group immediately, hence a reduction in signaling overhead.

In one embodiment, the action that the first logical channel group is retained comprises: configurations of a Radio Bearer (RB) to which the first logical channel group belongs are retained.

In one embodiment, the action that the first logical channel group is retained comprises: configurations of a Radio Bearer (RB) to which the first logical channel group belongs are retained.

In one embodiment, the action that the first logical channel group is retained comprises: a Radio Bearer (RB) to which the first logical channel group belongs is retained.

In one embodiment, advantages of the above method are as follows: configurations of an RB to which the first logical channel group belongs that are retained can be utilized in follow-up process to activate the RB to which the first logical channel group belongs immediately, hence a reduction in signaling overhead.

In one embodiment, the configurations of the first logical channel group comprise at least one of a Buffer Status Report (BSR) configuration or a logical channel group identity.

In one embodiment, the logical channel group identity in the present disclosure is a non-negative integer.

In one embodiment, the logical channel group identity in the present disclosure is no greater than 64.

In one embodiment, the logical channel group identity in the present disclosure is no greater than 10000.

In one embodiment, configurations of any logical channel in the first logical channel group comprise at least one of an identity, a priority, or a Scheduling Request (RS) identity of the logical channel, or a logical channel group identity.

In one embodiment, configurations of an RB to which the first logical channel group belongs include at least one of an RB identity, a PDCP entity configuration, a SDAP entity configuration, an RLC entity configuration or a logical channel configuration.

In one embodiment, configurations of an RB to which the first logical channel group belongs include at least one of an RB identity, a PDCP configuration, a SDAP configuration, an RLC Bearer configuration or a MAC configuration.

In one embodiment, upon reception of the first signaling, using the non-unicast RNTI for monitoring on a scheduling signaling in an air interface for data transmitted through the first logical channel group will be stopped.

In one embodiment, a non-unicast RNTI used for monitoring a scheduling signaling in an air interface for a first signaling is different from a non-unicast RNTI used for monitoring a scheduling signaling in an air interface for data transmitted through the first logical channel group.

In one embodiment, a non-unicast RNTI used for monitoring a scheduling signaling in an air interface for a first signaling is the same as a non-unicast RNTI used for monitoring a scheduling signaling in an air interface for data transmitted through the first logical channel group.

In one embodiment, upon reception of the first signaling, using the non-unicast RNTI for monitoring on data transmitted through the first logical channel group will be stopped.

In one embodiment, upon reception of the first signaling, using the unicast RNTI for monitoring on a scheduling signaling in an air interface for data transmitted through the second logical channel group will be started.

In one embodiment, upon reception of the first signaling, using the unicast RNTI for monitoring on data transmitted through the second logical channel group will be started.

In one embodiment, the first signaling comprises a first field.

In one subembodiment, the first field indicates an identity of the first logical channel group.

In one subembodiment, the first field indicates an identity of any logical channel in the first logical channel group.

In one subembodiment, the first field indicates an identity of at least one logical channel in the first logical channel group.

In one subembodiment, the first field indicates an identity of an RB to which the first logical channel group belongs.

In one embodiment, an identity of the first logical channel group is a non-negative integer.

In one subembodiment, the identity of the first logical channel group is no greater than 64.

In one subembodiment, the identity of the first logical channel group is no greater than 10000.

In one embodiment, an identity of any logical channel in the first logical channel group is a non-negative integer.

In one subembodiment, the identity of any logical channel in the first logical channel group is no greater than 64.

In one subembodiment, the identity of any logical channel in the first logical channel group is no greater than 10000.

In one embodiment, an identity of an RB to which the first logical channel group belongs is a non-negative integer.

In one subembodiment, the identity of the RB to which the first logical channel group belongs is no greater than 64.

In one subembodiment, the identity of the RB to which the first logical channel group belongs is no greater than 10000.

### Embodiment 6

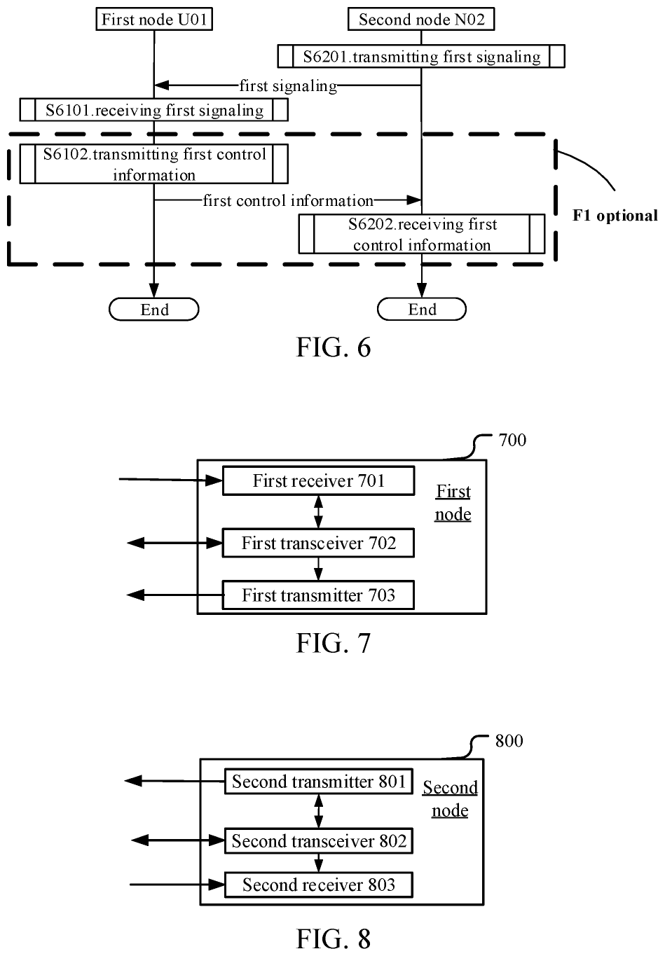

Embodiment 6 illustrates a flowchart of signal transmission according to another embodiment of the present disclosure, as shown in FIG. 6. It should be particularly noted that the sequence illustrated herein does not set any limit to the signal transmission order or implementation order in the present disclosure.

The first node U01 receives a first signaling in step S6101, the first signaling indicating a first threshold, the first threshold being used to determine release of the second logical channel group; and transmits first control information in step S6102, the first control information indicating that the second logical channel group is released.

The second node N02 transmits a first signaling in step S6201; and receives first control information in step S6202.

In Embodiment 6, the first logical channel group comprises at least one logical channel, and the second logical channel group comprises at least one logical channel; data transmitted through the first logical channel group and data transmitted through the second logical channel group are associated with a PDCP entity.

In one embodiment, the action that the second logical channel group is released comprises: configurations of the second logical channel group are released.

In one embodiment, the action that the second logical channel group is released comprises: at least one logical channel in the second logical channel group is released.

In one embodiment, the action that the second logical channel group is released comprises: configuration of at least one logical channel in the second logical channel group is released.

In one embodiment, the action that the second logical channel group is released comprises: any logical channel in the second logical channel group is released.

In one embodiment, the action that the second logical channel group is released comprises: configuration of any logical channel in the second logical channel group is released.

In one embodiment, the action that the second logical channel group is released comprises: each logical channel in the second logical channel group is released.

In one embodiment, the action that the second logical channel group is released comprises:

configurations of all logical channels in the second logical channel group are released.

In one embodiment, the action that the second logical channel group is released comprises: reception of data transmitted through the second logical channel group is halted.

In one embodiment, the action that the second logical channel group is released comprises: monitoring on data transmitted through the second logical channel group is halted.

In one embodiment, the action that the second logical channel group is released comprises: stopping monitoring on a scheduling signaling in an air interface for the data transmitted through the second logical channel group.

In one embodiment, the action that the second logical channel group is released comprises: configurations of a Radio Bearer (RB) to which the second logical channel group belongs are released.

In one embodiment, the action that the second logical channel group is released comprises: a Radio Bearer (RB) to which the second logical channel group belongs is released.

In one subembodiment, the action that a Radio Bearer (RB) to which the second logical channel group belongs is released comprises: a PDCP entity of a Radio Bearer (RB) to which the second logical channel group belongs is released.

In one subembodiment, the action that a Radio Bearer (RB) to which the second logical channel group belongs is released comprises: an RLC entity of a Radio Bearer (RB) to which the second logical channel group belongs is released.

In one subembodiment, the action that a Radio Bearer (RB) to which the second logical channel group belongs is released comprises: a logical channel for an RLC entity of a Radio Bearer (RB) to which the second logical channel group belongs is released.

In one subembodiment, the action that a Radio Bearer (RB) to which the second logical channel group belongs is released comprises: a logical channel for a Radio Bearer (RB) to which the second logical channel group belongs is released.

In one embodiment, the phrase that the first threshold being used to determine release of the second logical channel group comprises: when a second sequence number is greater than or equal to a first threshold, the second logical channel group is released.

In one embodiment, the phrase that the first threshold being used to determine release of the second logical channel group comprises: when a second sequence number is greater than a first threshold, the second logical channel group is released.

In one embodiment, the phrase that the first threshold being used to determine release of the second logical channel group comprises: when a second sequence number is equal to a first threshold, the second logical channel group is released.

In one embodiment, the phrase that the first threshold being used to determine release of the second logical channel group comprises: when a second sequence number is less than a first threshold, the second logical channel group is released.

In one embodiment, the phrase that the first threshold being used to determine release of the second logical channel group comprises: when a difference between a second sequence number and a first sequence number is less than a first threshold, the second logical channel group is released.

In one subembodiment, the phrase of a difference between a second sequence number and a first sequence number comprises: an absolute value of a difference between the second sequence number and the first sequence number.

In one subembodiment, a difference between a second sequence number and a first sequence number is equal to the second sequence number being subtracted by the first sequence number.

In one subembodiment, a difference between a second sequence number and a first sequence number is equal to the first sequence number being subtracted by the second sequence number.

In one embodiment, the second sequence number in the present disclosure comprises: a sequence number of a first-type packet occupied by data transmitted through the second logical channel group.

In one subembodiment, the first-type packet is successfully received.

In one subembodiment, the first-type packet is correctly received.

In one subembodiment, the first-type packet is in a receiving window, the receiving window belonging to a protocol layer to which the first-type packet belongs.

In one subembodiment, the first-type packet is a largest first-type packet among all first-type packets occupied by data transmitted through the second logical channel group.

In one subembodiment, the first-type packet is a smallest first-type packet among all first-type packets occupied by data transmitted through the second logical channel group.

In one embodiment, a sequence number of the first-type packet comprises: Sequence Number (SN).

In one embodiment, a sequence number of the first-type packet comprises: Hyper-Frame Number (HFN).

In one embodiment, a sequence number of the first-type packet comprises: COUNT value.

In one embodiment, the COUNT value is composed of SN and HFN.

In one embodiment, the first sequence number in the present disclosure comprises: a sequence number of a first-type packet occupied by data transmitted through the first logical channel group.

In one subembodiment, the first-type packet is successfully received.

In one subembodiment, the first-type packet is correctly received.

In one subembodiment, the first-type packet is in a receiving window, the receiving window belonging to a protocol layer to which the first-type packet belongs.

In one subembodiment, the first-type packet is a largest first-type packet among all first-type packets occupied by data transmitted through the first logical channel group.

In one subembodiment, the first-type packet is a smallest first-type packet among all first-type packets occupied by data transmitted through the first logical channel group.

In one embodiment, a sequence number of the first-type packet comprises: Sequence Number (SN).

In one embodiment, a sequence number of the first-type packet comprises: Hyper-Frame Number (HFN).

In one embodiment, a sequence number of the first-type packet comprises: COUNT value.

In one embodiment, the COUNT value is composed of SN and HFN.

In one embodiment, the phrase that the first threshold being used to determine release of the second logical channel group comprises: upon reception of the first signaling, a first timer is started; when the first timer expires, the second logical channel group is released.

In one embodiment, the action that the first timer is started comprises: the first timer is set to the first threshold.

In one embodiment, the action that the first timer is started comprises: the first timer is set to 0.

In one embodiment, the phrase that the first timer expires comprises: the first timer is of a value equal to the first threshold.

In one embodiment, the phrase that the first timer expires comprises: the first timer is of a value greater than the first threshold.

In one embodiment, advantages of the above method are as follows: there will be no need to indicate release of the second logical channel group by another signaling, thus reducing signaling overhead.

In one embodiment, the first control information is transmitted by a first control PDU, the first control PDU indicating the first control information.

In one embodiment, protocol layers to which the first control PDU belongs comprise a PDCP layer.

In one embodiment, protocol layers to which the first control PDU belongs comprise an RLC layer.

In one embodiment, protocol layers to which the first control PDU belongs comprise a SDAP layer.

In one embodiment, the first control information is transmitted by a second signaling.

In one embodiment, the second signaling comprises a MAC Control Element (CE).

In one embodiment, the second signaling comprises an RRC signaling.

In one embodiment, the second signaling comprises all or part of a RRCReconfiguration message.

In one embodiment, the second signaling comprises all or part of a RRCConnectionReconfiguration message.

In one embodiment, the second signaling comprises a Radio Resource Control (RRC) Message.

In one embodiment, the second signaling comprises all or part of Information Elements (IEs) in an RRC message.

In one embodiment, the second signaling comprises all or part of fields of an IE in an RRC message.

In one embodiment, the second signaling comprises a higher-layer signaling.

In one embodiment, the second signaling comprises DCI.

In one embodiment, the second signaling comprises a physical-layer signaling.

In one embodiment, the second signaling is transmitted on a Physical Uplink Shared Channel (PUSCH).

In one embodiment, the second signaling is transmitted on a Physical Uplink Control Channel (PUCCH).

In one embodiment, the second signaling is transmitted on a PSSCH.

In one embodiment, advantages of the above method are as follows: guaranteeing lossless transmission of broadcast/multicast data in an air interface as a PTP transmission mode is switched to a PTM transmission mode.

In one embodiment, the first control information is transmitted through a logical channel group other than the first logical channel group and the second logical channel group.

In one embodiment, the first control information is transmitted through a Radio Bearer (RB) other than an RB to which the first logical channel group belongs and an RB to which the second logical channel group belongs.

In one embodiment, advantages of the above method are as follows: a receiver receiving the second signaling is able to release resources corresponding to the second logical channel group, thereby increasing the resource utilization ratio.

In one embodiment, advantages of the above method are as follows: extra RBs can be released, thus reducing the power consumption.

In one embodiment, the first control information comprises a second field.

In one subembodiment, the second field indicates an identity of the second logical channel group.

In one subembodiment, the second field indicates an identity of any logical channel in the second logical channel group.

In one subembodiment, the second field indicates an identity of at least one logical channel in the second logical channel group.

In one subembodiment, the second field indicates an identity of an RB to which the second logical channel group belongs.

In one embodiment, the dotted-line box F1 is optional.

In one embodiment, the dotted-line box F1 exists.

In one embodiment, the dotted-line box F1 does not exist.

### Embodiment 7

FIG. 7 illustrates a structure block diagram of a processing device used in a first node according to one embodiment of the present disclosure; as shown in FIG. 7. In FIG. 7, a processing device 700 in the first node is comprised of a first receiver 701, a first transceiver 702 and a first transmitter 703.

A first receiver 701 receives a first signaling, the first signaling being used to determine release of only one of a first logical channel group or a second logical channel group.

In Embodiment 7, the first logical channel group comprises at least one logical channel, and the second logical channel group comprises at least one logical channel; data transmitted through the first logical channel group and data transmitted through the second logical channel group are associated with a PDCP entity.

In one embodiment, the first signaling comprises all or part of a RRCReconfiguration message.

In one embodiment, the first signaling comprises all or part of a RRCConnectionReconfiguration message.

In one embodiment, the first information comprises a Radio Resource Control (RRC) message.

In one embodiment, the phrase of the first signaling being used to determine release of only one of a first logical channel group or a second logical channel group comprises: upon reception of the first signaling, stopping receiving data through the first logical channel group, the second logical channel group being activated.

In one embodiment, the phrase of the first signaling being used to determine release of only one of a first logical channel group or a second logical channel group comprises: upon reception of the first signaling, stopping receiving data through the second logical channel group, the second logical channel group being activated.

In one embodiment, the phrase of the first signaling being used to determine release of only one of a first logical channel group or a second logical channel group comprises: upon reception of the first signaling, stopping receiving data through the first logical channel group, the second logical channel group being activated.

In one embodiment, the phrase of the first signaling being used to determine release of only one of a first logical channel group or a second logical channel group comprises: upon reception of the first signaling, stopping receiving data through the second logical channel group, the second logical channel group being activated.

In one embodiment, the phrase of the first signaling being used to determine release of only one of a first logical channel group or a second logical channel group comprises: when the first signaling is identified by a non-unicast RNTI, the first logical channel group is released; when the first signaling is identified by a unicast RNTI, the first logical channel group is retained.

In one embodiment, the phrase of the first signaling being used to determine release of only one of a first logical channel group or a second logical channel group comprises: the first signaling indicates a first threshold, the first threshold being used to determine release of the second logical channel group.

The first transmitter 703 transmits first control information.

In one embodiment, the first control information is transmitted by a first control PDU, the first control PDU indicating the first control information.

In one embodiment, protocol layers to which the first control PDU belongs comprise a PDCP layer.

In one embodiment, protocol layers to which the first control PDU belongs comprise an RLC layer.

In one embodiment, the first control information is transmitted by a second signaling.

In one embodiment, the second signaling comprises all or part of Information Elements (IEs) in an RRC message.

In one embodiment, the second signaling comprises all or part of fields of an IE in an RRC message.

In one embodiment, the second signaling comprises a higher-layer signaling.

In one embodiment, the first receiver 701 comprises the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 701 comprises the antenna 452, the receiver 454, the multi-antenna receiving processor 458 and the receiving processor 456 in FIG. 4 of the present disclosure.

In one embodiment, the first receiver 701 comprises the antenna 452, the receiver 454 and the receiving processor 456 in FIG. 4 of the present disclosure.

In one embodiment, the first transceiver 702 comprises the antenna 452, the receiver 454, the multi-antenna receiving processor 458, the receiving processor 456, the controller/processor 459, the memory 460 and the data source 467, the transmitter 454, the multi-antenna transmitting processor 457 and the transmitting processor 468 in FIG. 4 of the present disclosure.

In one embodiment, the first transceiver 702 comprises the antenna 452, the receiver 454, the multi-antenna receiving processor 458, the receiving processor 456, the transmitter 454, the multi-antenna transmitting processor 457 and the transmitting processor 468 in FIG. 4 of the present disclosure.

In one embodiment, the first transceiver 702 comprises the antenna 452, the receiver 454, the receiving processor 456, the transmitter 454 and the transmitting processor 468 in FIG. 4 of the present disclosure.

In one embodiment, the first transmitter 703 comprises the antenna 452, the transmitter 454, the multi-antenna transmitting processor 457, the transmitting processor 468, the controller/processor 459, the memory 460 and the data source 467 in FIG. 4 of the present disclosure.

In one embodiment, the first transmitter 703 comprises the antenna 452, the transmitter 454, the multi-antenna transmitting processor 457 and the transmitting processor 468 in FIG. 4 of the present disclosure.

In one embodiment, the first transmitter 703 comprises the antenna 452, the transmitter 454 and the transmitting processor 468 in FIG. 4 of the present disclosure.

### Embodiment 8

FIG. 8 illustrates a structure block diagram of a processing device used in a second node according to one embodiment of the present disclosure; as shown in FIG. 8. In FIG. 8, a processing device 800 in the second node is comprised of a second transmitter 801, a second transceiver 802 and a second receiver 803.

The second transmitter 801 transmits a first signaling, the first signaling being used to determine release of only one of a first logical channel group or a second logical channel group.

In Embodiment 8, the first logical channel group comprises at least one logical channel, and the second logical channel group comprises at least one logical channel; data transmitted through the first logical channel group and data transmitted through the second logical channel group are associated with a PDCP entity.

The second receiver 803 receives first control information.

In one embodiment, the second transmitter 801 comprises the antenna 420, the transmitter 418, the multi-antenna transmitting processor 471, the transmitting processor 416, the controller/processor 475 and the memory 476 in FIG. 4 of the present disclosure.

In one embodiment, the second transmitter 801 comprises the antenna 420, the transmitter 418, the multi-antenna transmitting processor 47 land the transmitting processor 416 in FIG. 4 of the present disclosure.

In one embodiment, the second transmitter 801 comprises the antenna 420, the transmitter 418 and the transmitting processor 416 in FIG. 4 of the present disclosure.

In one embodiment, the second transceiver 802 comprises the antenna 420, the transmitter 418, the multi-antenna transmitting processor 471, the transmitting processor 416, the controller/processor 475 and the memory 476, the receiver 418, the multi-antenna receiving processor 472, the receiving processor 470 and the memory 476 in FIG. 4 of the present disclosure.

In one embodiment, the second transceiver 802 comprises the antenna 420, the transmitter 418, the multi-antenna transmitting processor 471, the transmitting processor 416, the receiver 418, the multi-antenna receiving processor 472 and the receiving processor 470 in FIG. 4 of the present disclosure.

In one embodiment, the second transceiver 802 comprises the antenna 420, the transmitter 418, the transmitting processor 416, the receiver 418 and the receiving processor 470 in FIG. 4 of the present disclosure.

In one embodiment, the second receiver 803 comprises the antenna 420, the receiver 418, the multi-antenna receiving processor 472, the receiving processor 470, the controller/processor 475 and the memory 476 in FIG. 4 of the present disclosure.

In one embodiment, the second receiver 803 comprises the antenna 420, the receiver 418, the multi-antenna receiving processor 472 and the receiving processor 470 in FIG. 4 of the present disclosure.

In one embodiment, the second receiver 803 comprises the antenna 420, the receiver 418 and the receiving processor 470 in FIG. 4 of the present disclosure.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present disclosure is not limited to any combination of hardware and software in specific forms. The UE and terminal in the present disclosure include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present disclosure includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, receiving a first signaling, the first signaling being used to determine release of only one of a first logical channel group or a second logical channel group;
wherein the first logical channel group comprises at least one logical channel, and the second logical channel group comprises at least one logical channel; data transmitted through the first logical channel group and data transmitted through the second logical channel group are associated with a PDCP entity; the first signaling comprises all or part of a RRCReconfiguration message; the phrase that the data transmitted through the first logical channel group and data transmitted through the second logical channel group are associated with a PDCP entity comprises: the first logical channel group and the second logical channel group are respectively associated with two RLC entities, and the two RLC entities are associated with the PDCP entity.

2. The first node according to claim 1, wherein the phrase of the first signaling being used to determine release of only one of a first logical channel group or a second logical channel group means:
when the first signaling is identified by a non-unicast RNTI, the first logical channel group is released; when the first signaling is identified by a unicast RNTI, the first logical channel group is retained.

3. The first node according to claim 1, wherein the phrase of the first signaling being used to determine release of only one of a first logical channel group or a second logical channel group means:
the first signaling indicates a first threshold, the first threshold being used to determine release of the second logical channel group.

4. The first node according to claim 3, wherein
when a second sequence number is greater than or equal to a first threshold, the second logical channel group is released; when a difference between a second sequence number and a first sequence number is less than a first threshold, the second logical channel group is released; the first sequence number comprises: a sequence number of a first-type packet occupied by data transmitted through the first logical channel group; the sequence number of the first-type packet comprises at least one of an SN or a COUNT value.

5. The first node according to claim 3, wherein
the first receiver, upon whose reception of the first signaling, a first timer is started; when the first timer expires, the second logical channel group is released.

6. The first node according to claim 3, comprising:
a first transmitter, transmitting first control information, the first control information indicating that the second logical channel group is released; the first control information is transmitted via a second signaling; the first control information is transmitted through a logical channel group other than a first logical channel group and a second logical channel group.

7. The first node according to claim 6, wherein
the second signaling comprises a MAC Control Element (CE).

8. The first node according to claim 6, wherein
the second signaling is transmitted on a PSSCH.

9. The first node according to claim 1, characterized in that:
a scheduling signaling in an air interface for the data transmitted through the first logical channel group is identified by a non-unicast RNTI, and a scheduling signaling in an air interface for the data transmitted through the second logical channel group is identified by a unicast RNTI.

10. The first node according to claim 9, wherein the phrase of the first signaling being used to determine release of only one of a first logical channel group or a second logical channel group means:
when the first signaling is identified by a non-unicast RNTI, the first logical channel group is released; when the first signaling is identified by a unicast RNTI, the first logical channel group is retained.

11. The first node according to claim 1, characterized in that:
the phrase of the first signaling being used to determine release of only one of a first logical channel group or a second logical channel group comprises: stopping monitoring on a scheduling signaling in an air interface for the data transmitted through the first logical channel group, or, stopping monitoring on a scheduling signaling in an air interface for the data transmitted through the second logical channel group.

12. The first node according to claim 1, characterized in that:
a Radio Bearer (RB) to which the first logical channel group belongs comprises a Multicast Radio Bearer (MRB); in the present disclosure, an RB to which the first logical channel group belongs comprises a Bearer transmitted in a Point-to-MultiPoint (PTM) mode; an RB to which the second logical channel group belongs comprises a PTP branch; an RB to which the first logical channel group belongs comprises a PTM branch.

13. The first node according to claim 12, characterized in that:
a scheduling signaling in an air interface for the data transmitted through the first logical channel group is identified by a non-unicast RNTI, and a scheduling signaling in an air interface for the data transmitted through the second logical channel group is identified by a unicast RNTI.

14. The first node according to claim 13, characterized in that:
the phrase of the first signaling being used to determine release of only one of a first logical channel group or a second logical channel group comprises: stopping monitoring on a scheduling signaling in an air interface for the data transmitted through the first logical channel group, or, stopping monitoring on a scheduling signaling in an air interface for the data transmitted through the second logical channel group.

15. The first node according to claim 1, comprising:
the first signaling comprises configurations of the second logical channel group; the configurations of the second logical channel group comprise configuration of a Buffer Status Report (BSR).

16. The first node according to claim 15, characterized in that:
the first signaling comprises a first field; the first field indicates an identity of any logical channel in the first logical channel group; the action that the first logical channel group is released comprises: configurations of all logical channels in the first logical channel group are released.

17. The first node according to claim 15, characterized in that:
the phrase of the first signaling being used to determine release of only one of a first logical channel group or a second logical channel group comprises: upon reception of the first signaling, stopping receiving data through the first logical channel group, the second logical channel group being activated.

18. A second node for wireless communications, comprising:
a second transmitter, transmitting a first signaling, the first signaling being used to determine release of only one of a first logical channel group or a second logical channel group;
wherein the first logical channel group comprises at least one logical channel, and the second logical channel group comprises at least one logical channel; data transmitted through the first logical channel group and data transmitted through the second logical channel group are associated with a PDCP entity; the first signaling comprises all or part of a RRCReconfiguration message; the phrase that the data transmitted through the first logical channel group and data transmitted through the second logical channel group are associated with a PDCP entity comprises: the first logical channel group and the second logical channel group are respectively associated with two RLC entities, and the two RLC entities are associated with the PDCP entity.

19. A method in a first node for wireless communications, comprising:
receiving a first signaling, the first signaling being used to determine release of only one of a first logical channel group or a second logical channel group;
wherein the first logical channel group comprises at least one logical channel, and the second logical channel group comprises at least one logical channel; data transmitted through the first logical channel group and data transmitted through the second logical channel group are associated with a PDCP entity; the first signaling comprises all or part of a RRCReconfiguration message; the phrase that the data transmitted through the first logical channel group and data transmitted through the second logical channel group are associated with a PDCP entity comprises: the first logical channel group and the second logical channel group are respectively associated with two RLC entities, and the two RLC entities are associated with the PDCP entity.

20. A method in a second node for wireless communications, comprising:
transmitting a first signaling, the first signaling being used to determine release of only one of a first logical channel group or a second logical channel group;
wherein the first logical channel group comprises at least one logical channel, and the second logical channel group comprises at least one logical channel; data transmitted through the first logical channel group and data transmitted through the second logical channel group are associated with a PDCP entity; the first signaling comprises all or part of a RRCReconfiguration message; the phrase that the data transmitted through the first logical channel group and data transmitted through the second logical channel group are associated with a PDCP entity comprises: the first logical channel group and the second logical channel group are respectively associated with two RLC entities, and the two RLC entities are associated with the PDCP entity.
